(19) United States
(12) Patent Application Publication
(10) Pub. No.: US 2024/0116365 A1
(43) Pub. Date: Apr. 11, 2024

(54) Audio User Interface

(71) Applicant: Bose Corporation, Framingham, MA (US)

(72) Inventors: Steven J. Forrester, Southborough, MA (US); Robert A. Warden, Southborough, MA (US)

(21) Appl. No.: 18/376,592

(22) Filed: Oct. 4, 2023

Related U.S. Application Data
(60) Provisional application No. 63/414,003, filed on Oct. 7, 2022.

(51) Int. Cl. B60K 37/04

(52) U.S. Cl. CPC B60K 37/04; B60K 2370/143; B60K 2370/1468; B60K 2370/152; B60K 2370/157; B60K 2370/186; B60K 2370/52; B60K 2370/563

(57) ABSTRACT

Apparatuses, methods, and computer readable medium are provided for controlling an audio system in a vehicle. At least two sub-panels are presented via a display and at least one of the sub-panels provides one or more audio setting options for a first individual or group of occupant locations. The audio setting options are distinct relative to a second individual or group of occupant locations. User selections are received via an input sensor, such as a touchscreen incorporated into the display or separate buttons, knobs, touch-sensitive inputs, or the like. The audio system is controlled in accord with the user selections.

### CROSS-REFERENCE TO RELATED APPLICATIONS

This application is a continuation of U.S. Application No. 63/414,003, filed Oct. 7, 2022, which is incorporated herein by reference in its entirety.

### BACKGROUND

Automotive and vehicular audio systems are becoming more sophisticated over time, and now integrate various audio sources, such as radio broadcasts, nearby wireless devices, telephone calls, navigation prompts, streaming audio, and the like. Some audio systems do or will have seat specific audio adjustments, such as volume adjustment so that one occupant may listen to audio at a louder output than another occupant, or the ability to play different content to one occupant than another, e.g., navigation prompts only to the driver or telephone call audio only to the recipient or different music or audio sources to two different occupant positions. There exists a need for users to interact with the various user settings and preferences in a natural and easily understandable way.

### SUMMARY

Systems and methods disclosed herein are directed to user interface systems, methods, and applications for controlling audio output from an audio system.

According to various aspects an apparatus, method, and computer readable medium are provided for controlling an audio system in a vehicle that includes presenting at least two sub-panels via a display, at least one of the sub-panels including one or more audio setting options for at least one of a first individual or group of occupant locations in the vehicle to be distinct relative to a second individual or group of occupant locations in the vehicle, receiving user selections via an input sensor, and controlling the audio system in accord with the user selections.

In some examples, the second individual or group of occupant locations in the vehicle comprise all occupant locations in the vehicle that are not included in the first individual or group of occupant locations.

According to various examples, the one or more audio setting options may include at least one of an incoming call routing, a volume setting, a front-to-rear attenuation or volume differential, and a distinct content selection wherein the first individual or group of occupant locations receives differing audio content relative to the second individual or group of occupant locations.

Certain examples may include selecting the one or more audio setting options based upon at least one of a time of day, a lighting condition, a vehicle condition, an environmental condition, or sensor data.

Various examples may include presenting audio setting information for the first individual or group of occupant locations in a first one of the at least two sub-panels and presenting audio setting information for the second individual or group of occupant locations in a second one of the at least two sub-panels. In some instances, audio setting options may be presented for the first individual or group of occupant locations in the first one of the at least two sub-panels and audio setting options for the second individual or group of occupant locations may be presented in the second one of the at least two sub-panels.

Various examples may include expanding or contracting at least one of the at least two sub-panels to occupy more or less of the display, respectively, in response to a user interacting with the at least one of the at least two sub-panels via the input sensor.

Still other aspects, examples, and advantages of these exemplary aspects and examples are discussed in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

FIG. 1 illustrates an example user interface display including options and/or settings for a light mode,

FIG. 2 illustrates an example user interface display including options and/or settings for a dark mode,

FIG. 3 illustrates an example user interface display including options and/or settings for an incoming call,

FIG. 4 illustrates an example user interface display including options and/or settings for selecting a routing location for an incoming call,

FIG. 5 illustrates an example user interface display including options and/or settings for selecting a routing location for an incoming call,

FIG. 6 illustrates an example user interface display including options and/or settings for a dual zone option during a call,

FIG. 7 illustrates an example user interface display including options and/or settings for a dual zone option during a call,

FIG. 8 illustrates an example user interface display including options and/or settings for a dual zone option during a call,

FIG. 9 illustrates an example user interface display including options and/or settings for a volume zone,

FIG. 10 illustrates an example user interface display including options and/or settings for a volume zone,

FIG. 11 illustrates an example user interface display including options and/or settings for a volume zone,

FIG. 12 illustrates an example user interface display including options and/or settings for an audio content zone,

FIG. 13 illustrates an example user interface display including options and/or settings for an audio content zone,

FIG. 14 illustrates an example user interface display including options and/or settings for an audio content zone,

FIG. 15 illustrates an example user interface display including options and/or settings for an audio content zone,

FIG. 16 illustrates an example user interface display including options and/or settings for an audio content zone,

FIG. 17 illustrates an example user interface display including options and/or settings for an audio content zone,

FIG. 18 illustrates an example user interface display including options and/or settings for an attenuation zone,

FIG. 19 illustrates an example user interface display including options and/or settings for an attenuation zone,

FIG. 20 illustrates an example user interface display including options and/or settings for an attenuation zone,

FIG. 21 illustrates an example user interface display including options and/or settings for an attenuation zone,

FIG. 22 illustrates an example user interface display including options and/or settings for an attenuation zone,

FIG. 23 illustrates an example user interface display including options and/or settings for an attenuation zone,

FIG. 24 illustrates an example user interface display including options and/or settings for an acoustic sound field experience,

FIG. 25 illustrates an example user interface display including options and/or settings for an acoustic sound field experience,

FIG. 26 illustrates an example user interface display including options and/or settings for an acoustic sound field experience,

FIG. 27 illustrates an example user interface display including options and/or settings for an incoming call,

FIG. 28 illustrates an example user interface display including options and/or settings for an incoming call,

FIG. 29 illustrates an example user interface display including options and/or settings for a dual zone option during a call,

FIG. 30 illustrates an example user interface display including options and/or settings for a sub-settings option,

FIG. 31 illustrates an example user interface display including options and/or settings for a sub-settings menu or display, and

FIG. 32 illustrates an example user interface display including options and/or settings for a sub-settings menu or display.

### DETAILED DESCRIPTION

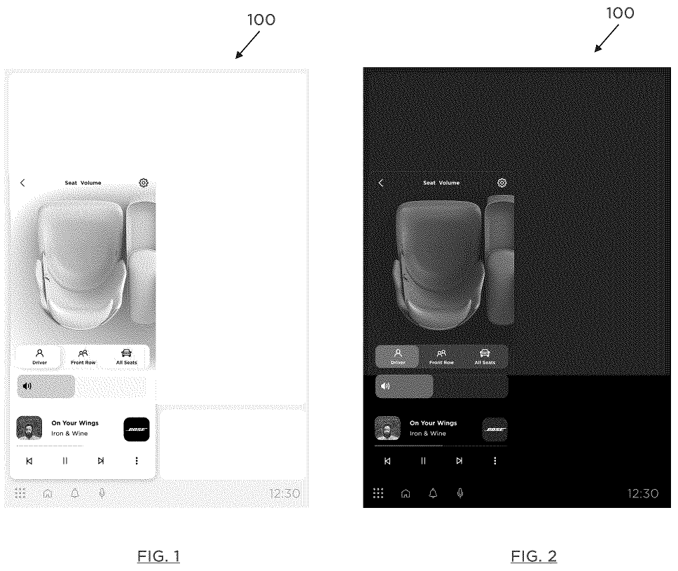

Various aspects, examples, and features of user interface systems, methods, and applications are illustrated by FIGS. 1-32.

FIGS. 1-2 illustrate a user interface display 100 having three panels: a main (large) panel that may display map or navigation data in some examples and two sub-panels (shown below the main panel). In this example, the left-most sub-panel is configured to display audio system information and to allow interaction with audio system controls and user settings and preferences.

In various examples user interaction may be accommodated in various ways, such as by the display 100 being a touchscreen (which incorporates an input sensor) or by alternate input sensors such as buttons, knobs, etc.

In the illustrated example, the audio system sub-panel has been selected by the user and illustrates an option to control volume settings for one of a driver, a front row, or all seats. FIG. 1 illustrates this display in a light mode and FIG. 2 illustrates a dark mode, as may be options in various examples. Light and dark modes may be configured to be automatically selected by the system, such as by time of day and/or light levels in the vehicle, or may be configured by a user selection, setting, or preference (which may further be stored in association with a user, such as by a user identifier, key fob, or vehicle memory setting associated with a particular user).

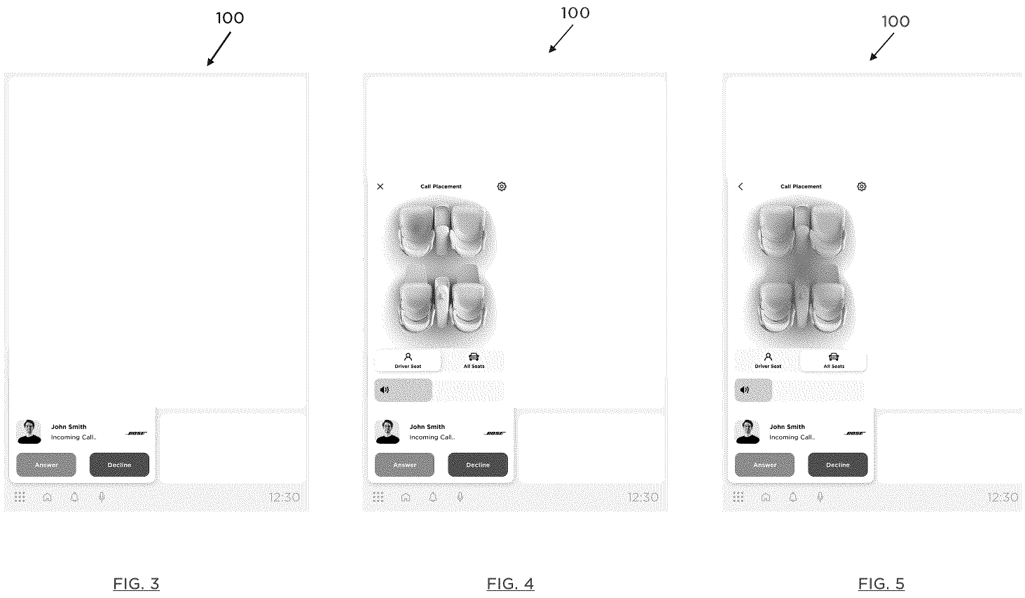

FIGS. 3-5 illustrate seat specific call placement or routing of telephone calls, as may be included in some examples. FIG. 3 shows a notification of an incoming call. In certain examples a contextual user interface to select where to route the call may be provided in the display and allow the selection of a driver seat (as in FIG. 4) or all seats (e.g., the entire vehicle) (as in FIG. 5). In some examples, specific seats other than the driver's seat may also be selectable.

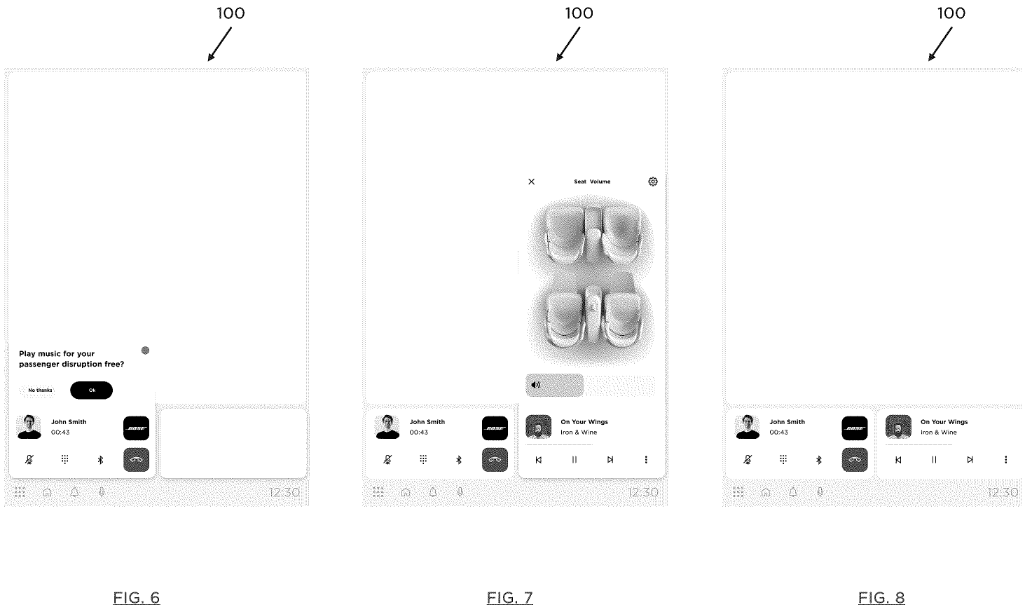

FIGS. 6-8 illustrate additional features of seat specific call placement. For instance, when a call is routed to a single seat, occupants in other seating locations may be able to continue listening to other content, such as entertainment audio. FIG. 6 illustrates an example display providing the option to allow the other audio content to play at another seat location while a call is active. In some examples, upon user selection to allow the other audio to play a secondary audio user interface may become active for controlling the other audio, such as volume or content selection, as illustrated in FIG. 7. In certain examples, the user interface may allocate two sub-panels for controlling each of two audio outputs, e.g., a telephone call audio to the driver location and entertainment audio to another occupant location, as shown in FIG. 8, wherein information is displayed about the two audio streams, and some user controls are provided, in each of two respective sub-panels of the user interface display.

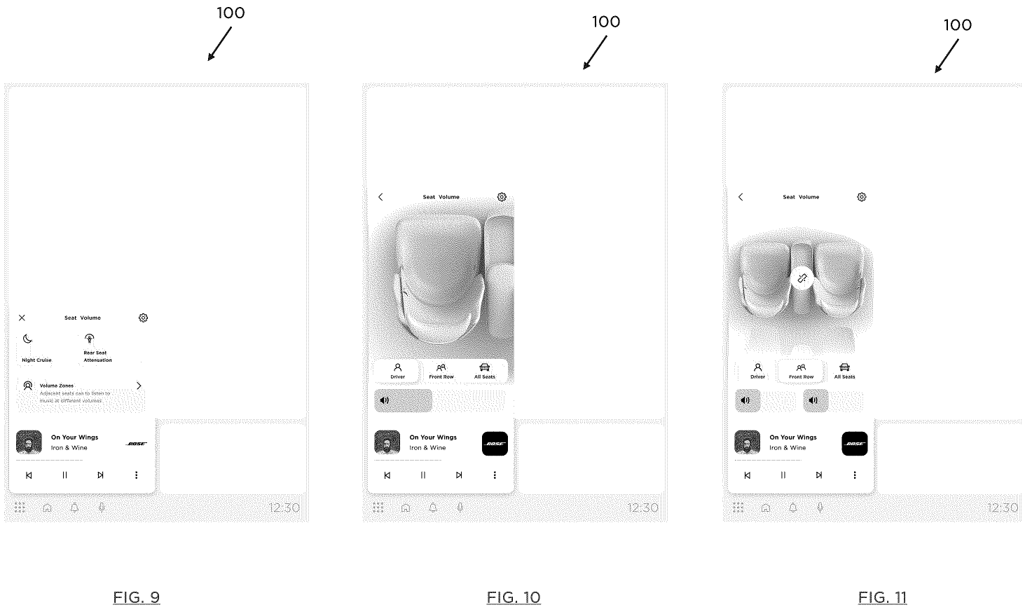

FIGS. 9-11 illustrate independent volume control in different zones of a vehicle. FIG. 9 shows contextual user settings options when the audio control sub-panel is activated and provides an option for volume zones in various examples. FIG. 10 illustrates an example volume zones sub-menu that may be displayed upon selection of the volume zones option, and further illustrates options to control volume for just the driver (or any specific seat in some examples) or for the front row (or other rows or groups of seats in various examples) or for all seats. FIG. 11 illustrate one example response to a user selection of front row, wherein independent volume controls for each of the seats in the front row are presented to the user(s).

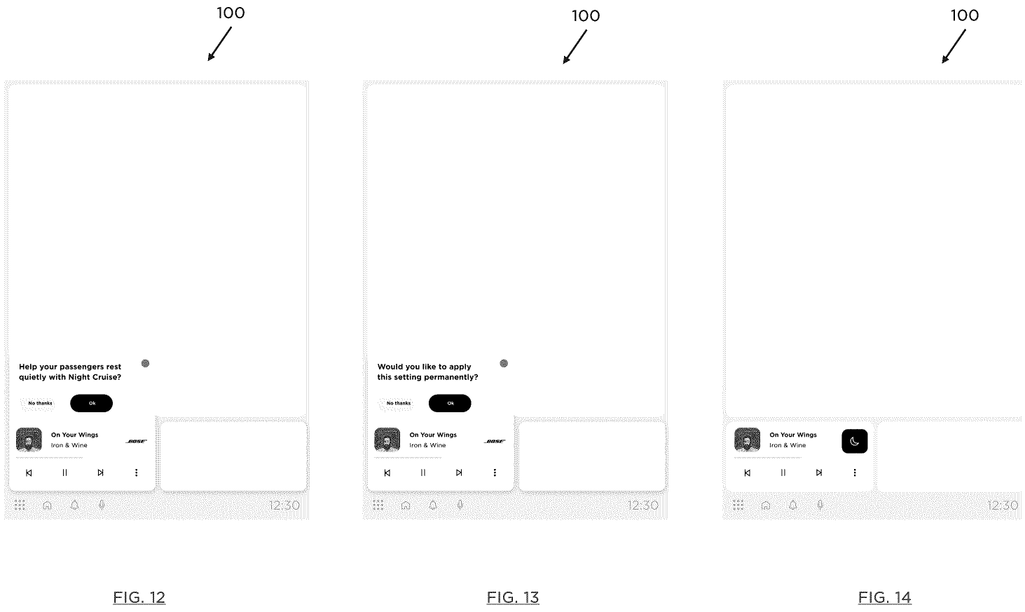

FIGS. 12-14 illustrate an option to enable a feature configured to help a driver stay awake while not disturbing passengers, or to help passengers sleep while not disrupting the driver, or both. FIG. 12 illustrates an example displayed menu option to enable this feature or not. In certain examples, vehicle and/or environmental conditions may trigger such a contextual prompt, such as after a certain time of day or exterior light conditions, or other information that may indicate that passenger relaxation and/or driver alertness may be desirable. FIG. 13 illustrates an example displayed menu option to turn on such a feature permanently or not, such as to preview or sample the mode rather than fully opt-in, for example. FIG. 14 illustrates an example variation in the audio control sub-panel to indicate when this feature is enabled, as shown by the ‘moon’ icon.

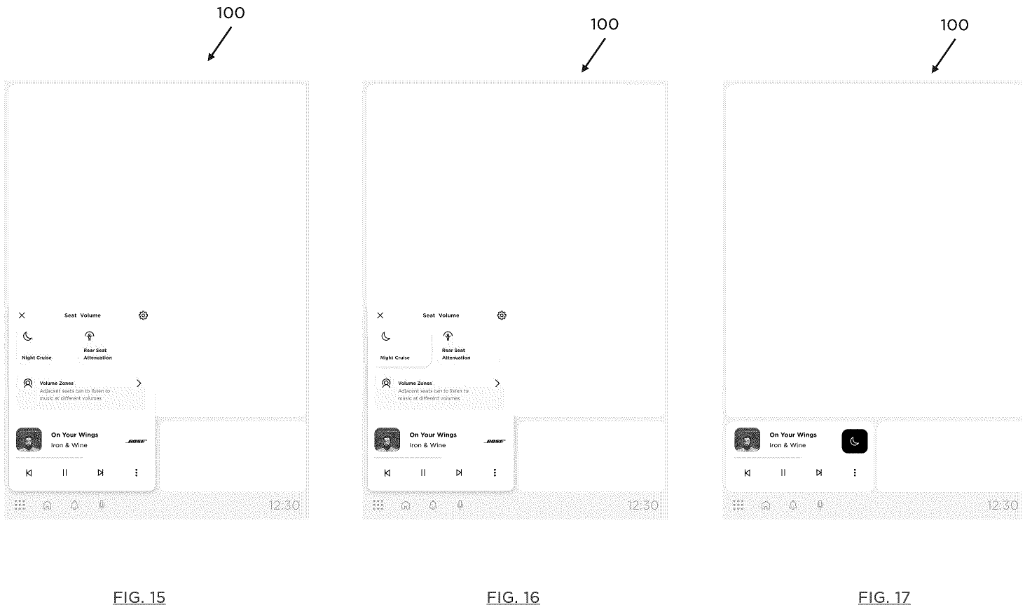

FIGS. 15-17 illustrate the feature of FIGS. 12-14 except that in FIGS. 15-17 initiation of the feature manually by the user, rather than by a prompt that may have been triggered by sensor or other vehicle and environmental information. FIG. 15 illustrates example contextual user settings options when the audio control sub-panel is activated. In this example, there is an option to select a “Night Cruise” feature. FIG. 16 illustrates the selection of the “Night Cruise” feature, and FIG. 17 is similar to FIG. 14 in that it illustrates an example variation in the audio control sub-panel to indicate when the “Night Cruise” feature is enabled, as shown by the ‘moon’ icon.

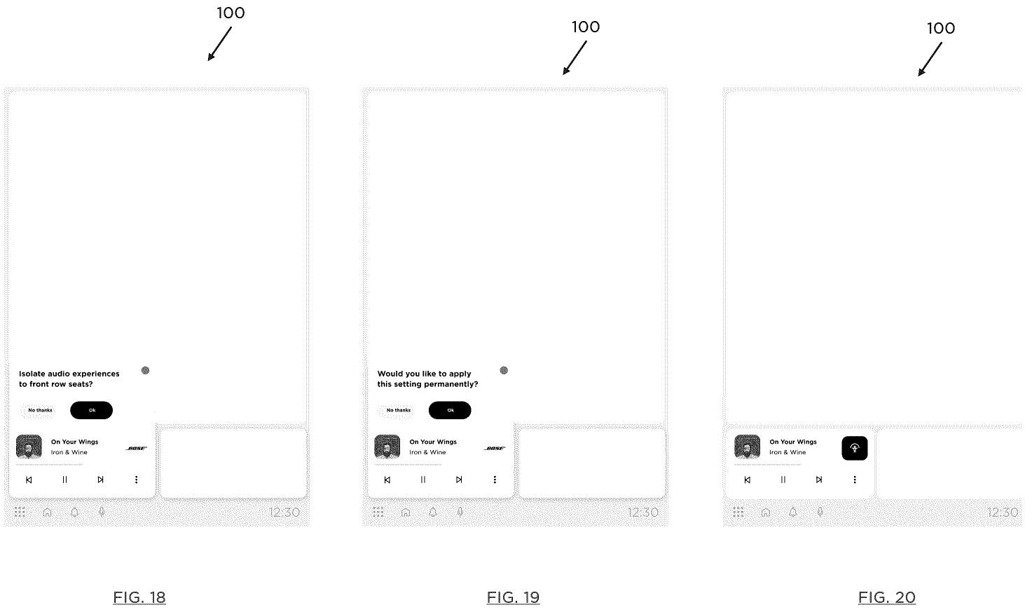

FIGS. 18-20 illustrate example user displays and settings options for a user interface to prompt a user to enable a feature for attenuation in a portion of the vehicle, such as to actively attenuate (or cancel) audio in the rear seats, such as to allow full spectral accuracy and tonal balance in the front seat while allowing rear seat passengers to hear less of the audio, so as not to interfere with their own entertainment options. Similarly to as discussed above, the prompt to enable this feature may be triggered by vehicle, environmental, and/or sensor data. FIG. 19 illustrates an example displayed menu option to turn on such a feature permanently or not, such as to preview or sample the mode rather than fully opt-in, for example. FIG. 20 illustrates an example variation in the audio control sub-panel to indicate when this feature is enabled, as shown by a specialized icon.

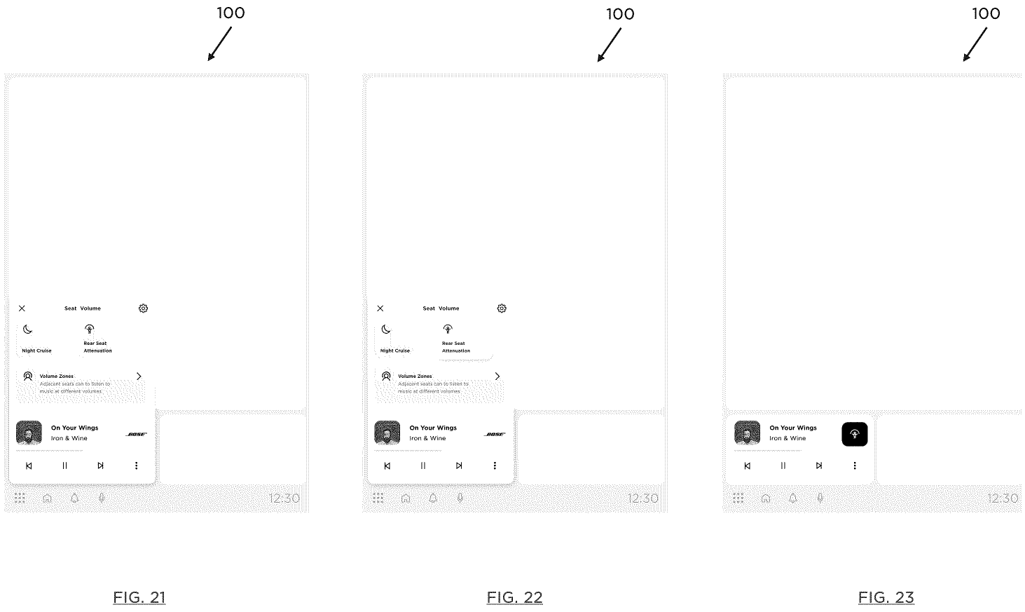

FIGS. 21-23 illustrate example user displays and settings options for manually enabling (unprompted) the attenuation feature of FIGS. 18-20. FIG. 21 illustrates example contextual user settings options when the audio control sub-panel is activated. In this example, there is an option to select a “Rear Seat Attenuation” feature. FIG. 22 illustrates the selection of the “Rear Seat Attenuation” feature, and FIG. 23 illustrates an example variation in the audio control sub-panel to indicate when this feature is enabled, as shown by a specialized icon, similar to that shown in FIG. 20.

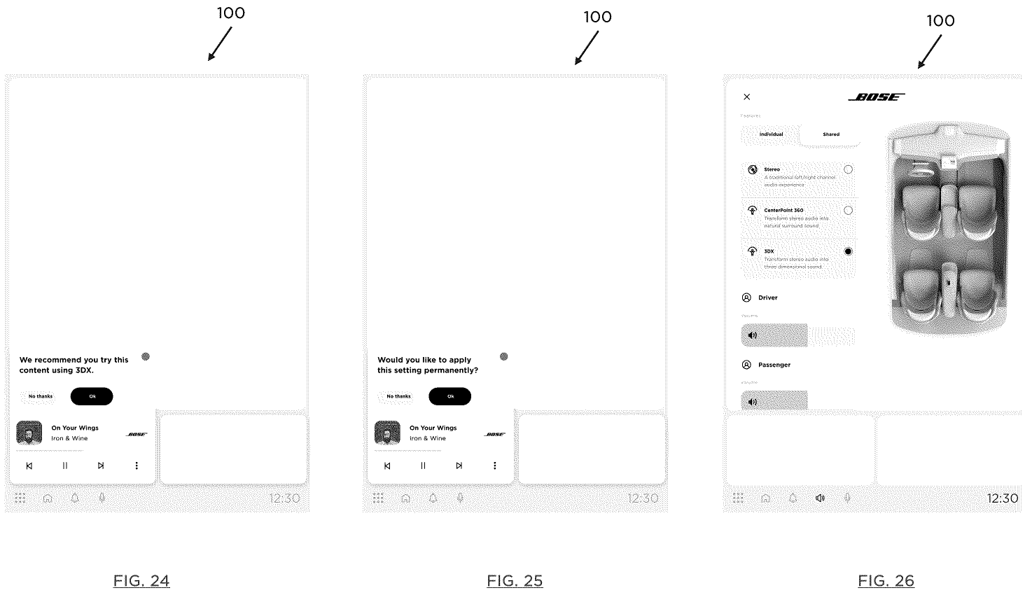

FIGS. 24-26 illustrate example user displays and settings options for a user interface to prompt a user to enable certain acoustic field sound experiences, such as to modify or adjust a soundstage distribution (e.g., location of a phantom center channel, stage width, and/or perceived left-right placement, height or elevated channels, etc.) or another aspect of the sound ambience, such as an amount of envelopment, or other various sound modes of the audio system. FIG. 24 illustrates a contextual prompt to enable a different sound mode, which may be displayed in response to certain sensor, vehicle, or environmental data or information. FIG. 25 illustrates an example displayed menu option to turn on such a feature permanently or not, such as to preview or sample the mode rather than fully opt-in, for example. In various examples, there may be numerous available differing sound modes and a user interface in accord with aspects and examples herein may switch at various times to use a main panel of the user interface display, as illustrated in at least one example in FIG. 26.

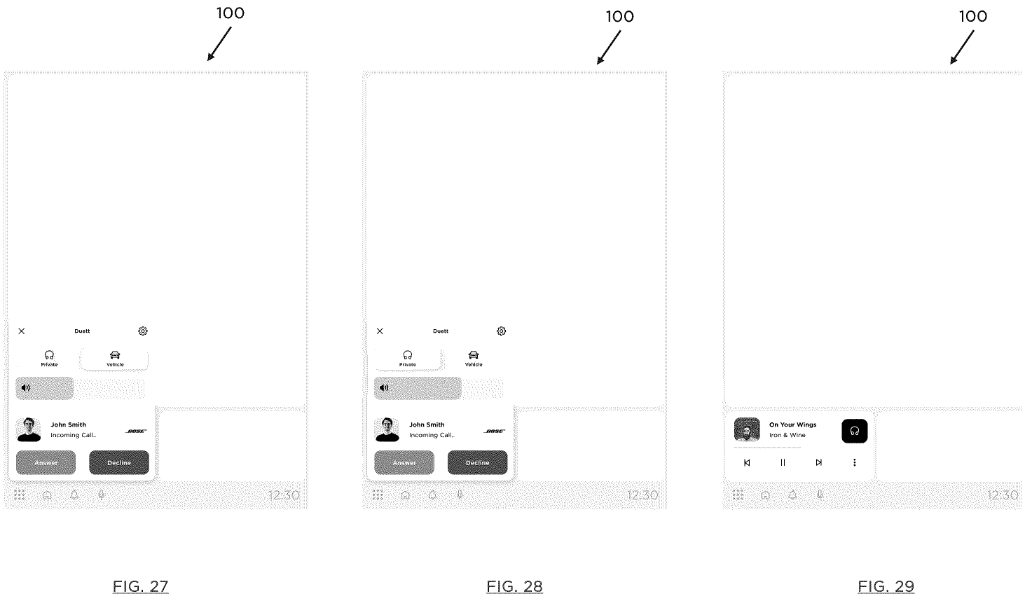

FIGS. 27-29 illustrate example user displays and settings options of a user interface for accepting an incoming call, particularly when the audio system allows for the call to be routed to one or more occupant locations in the vehicle. FIG. 27 illustrates an example notification of the incoming call along with a presentation of settings options for where to route the call in the vehicle. FIG. 28 illustrates that a selection of where to route the call may be made by the user before answering the call, and in some cases, an option to adjust volume may also be provided. In various examples, options for routing after answering are also provided. FIG. 29 illustrates an example variation in the audio control sub-panel to indicate that specialized audio (e.g., the phone call) is being delivered to an individual occupant location even though the audio system may be continuing to play entertainment audio for other occupant locations.

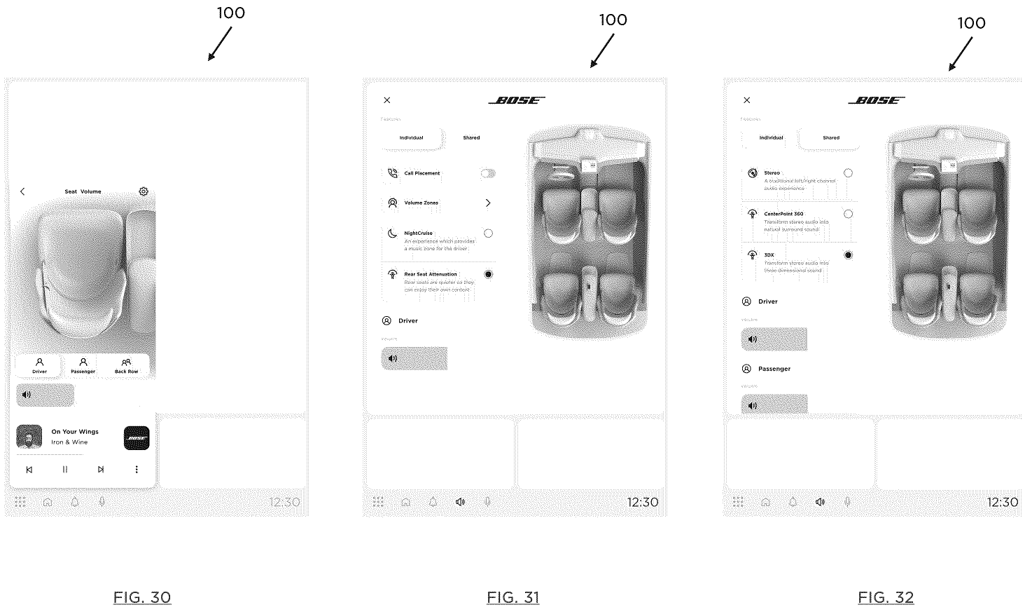

FIGS. 30-32 illustrate additional aspects of an example user interface system, method, and application. With further reference to FIGS. 15, 21, and 27, each of which illustrates an activated audio control sub-panel, such as when a user taps on the audio sub-panel in some examples, and also as shown in FIG. 30, there may be presented a ‘settings’ icon, e.g., an icon resembling a gear in this example, that may allow access to a broader settings menu for the audio system. In FIGS. 31-32, an example of such a broader settings menu is illustrated. In this example, the number of settings and options are such that the user interface may, in some cases, display in the main panel of the user display, as shown. FIG. 31 illustrates some examples of settings that may be applied to individual or groups of occupant locations, while FIG. 32 illustrates some examples of settings that may be applied to, or shared among, all occupant positions.

Examples of the methods and apparatuses discussed herein are not limited in application to the details of construction and the arrangement of components set forth in the above descriptions or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Also, the phraseology and terminology used herein is for the purpose of description and should not be regarded as limiting. Any references to examples, components, elements, acts, or functions of the systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation, unless the context reasonably implies otherwise.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An apparatus for controlling an audio system in a vehicle comprising:
a display;
an input sensor to accept user selections coupled to the display; and
a controller coupled to the display, the input sensor, and the audio system, the controller configured to present at least two sub-panels via the display, at least one of the sub-panels including one or more audio setting options for at least one of a first individual or group of occupant locations in the vehicle to be distinct relative to a second individual or group of occupant locations in the vehicle, the controller also configured to receive user selections via the input sensor and to control the audio system in accord with the user selections.

2. The apparatus of claim 1 wherein the second individual or group of occupant locations in the vehicle comprise all occupant locations in the vehicle that are not included in the first individual or group of occupant locations.

3. The apparatus of claim 1 wherein the one or more audio setting options include at least one of an incoming call routing, a volume setting, a front-to-rear attenuation or volume differential, and a distinct content selection wherein the first individual or group of occupant locations receives differing audio content relative to the second individual or group of occupant locations.

4. The apparatus of claim 1 wherein the controller is further configured to select the one or more audio setting options based upon at least one of a time of day, a lighting condition, a vehicle condition, an environmental condition, and a sensor data.

5. The apparatus of claim 1 wherein the controller is further configured to present audio setting information for the first individual or group of occupant locations in a first one of the at least two sub-panels and to present audio setting information for the second individual or group of occupant locations in a second one of the at least two sub-panels.

6. The apparatus of claim 5 wherein the controller is further configured to present audio setting options for the first individual or group of occupant locations in the first one of the at least two sub-panels and to present audio setting options for the second individual or group of occupant locations in the second one of the at least two sub-panels.

7. The apparatus of claim 1 wherein the controller is further configured to expand or contract at least one of the at least two sub-panels to occupy more or less of the display, respectively, in response to a user interacting with the at least one of the at least two sub-panels via the input sensor.

8. A method of controlling an audio system in a vehicle, the method comprising:
displaying at least two sub-panels via a display, at least one of the sub-panels including one or more audio setting options for at least one of a first individual or group of occupant locations in the vehicle to be distinct relative to a second individual or group of occupant locations in the vehicle;
receiving user selections via an input sensor; and
controlling the audio system in accord with the user selections.

9. The method of claim 8 wherein the second individual or group of occupant locations in the vehicle comprise all occupant locations in the vehicle that are not included in the first individual or group of occupant locations.

10. The method of claim 8 wherein the one or more audio setting options include at least one of an incoming call routing, a volume setting, a front-to-rear attenuation or volume differential, and a distinct content selection wherein the first individual or group of occupant locations receives differing audio content relative to the second individual or group of occupant locations.

11. The method of claim 8 further comprising selecting the one or more audio setting options based upon at least one of a time of day, a lighting condition, a vehicle condition, an environmental condition, and a sensor data.

12. The method of claim 8 further comprising presenting audio setting information for the first individual or group of occupant locations in a first one of the at least two sub-panels and presenting audio setting information for the second individual or group of occupant locations in a second one of the at least two sub-panels.

13. The method of claim 12 further comprising presenting audio setting options for the first individual or group of occupant locations in the first one of the at least two sub-panels and presenting audio setting options for the second individual or group of occupant locations in the second one of the at least two sub-panels.

14. The method of claim 8 further comprising expanding or contracting at least one of the at least two sub-panels to occupy more or less of the display, respectively, in response to a user interacting with the at least one of the at least two sub-panels via the input sensor.

15. A non-transitory computer readable medium having instructions that, when executed by a processor, cause the processor to perform a method of controlling an audio system in a vehicle, the method comprising:
displaying at least two sub-panels via a display, at least one of the sub-panels including one or more audio setting options for at least one of a first individual or group of occupant locations in the vehicle to be distinct relative to a second individual or group of occupant locations in the vehicle;
receiving user selections via an input sensor; and
controlling the audio system in accord with the user selections.

16. The non-transitory computer readable medium of claim 15 wherein the second individual or group of occupant locations in the vehicle comprise all occupant locations in the vehicle that are not included in the first individual or group of occupant locations.

17. The non-transitory computer readable medium of claim 15 wherein the one or more audio setting options include at least one of an incoming call routing, a volume setting, a front-to-rear attenuation or volume differential, and a distinct content selection wherein the first individual or group of occupant locations receives differing audio content relative to the second individual or group of occupant locations.

18. The non-transitory computer readable medium of claim 15 further comprising selecting the one or more audio setting options based upon at least one of a time of day, a lighting condition, a vehicle condition, an environmental condition, and a sensor data.

19. The non-transitory computer readable medium of claim 15 further comprising presenting audio setting information for the first individual or group of occupant locations in a first one of the at least two sub-panels and presenting audio setting information for the second individual or group of occupant locations in a second one of the at least two sub-panels.

20. The non-transitory computer readable medium of claim 15 further comprising expanding or contracting at least one of the at least two sub-panels to occupy more or less of the display, respectively, in response to a user interacting with the at least one of the at least two sub-panels via the input sensor.
